(19) United States
(12) Patent Application Publication
(10) Pub. No.: US 2001/0026914 A1
(43) Pub. Date: Oct. 4, 2001

(54) Method for training and internally qualifying a person in a particular field of study

(76) Inventors: David John Samuels, Billericay Essex (GB); Roscoe Nash JR., Plymouth, MI (US)

Correspondence Address: JOHN F. BUCKERT, FORD GLOBAL TECHNOLOGIES, INC., ONE PARKLANE BOULEVARD, 600 EAST PARKLANE TOWERS, DEARBORN, MI, 48126, US

(21) Appl. No.: 09/538,089

(22) Filed: Mar. 29, 2000

(51) Int. Cl. G09B 7/00

(52) U.S. Cl. 434/362

(57) ABSTRACT

A method of training and internally qualifying a person in a particular field of study is provided. The method includes the step 12 of determining if the person needs to take a training class prior to taking a second examination to become internally qualified in the field of study. The method further includes the step 14 of providing a training class related to the field of study. The method further includes the step 22 of providing a first examination containing questions related to instructional information provided in the training class. A score is determined on the first examination. The method further includes the step 26 of providing a project for the person wherein the instructional information from the training class is utilized to complete a task in the project. The method further includes the step 28 of providing a second examination containing questions related to the instructional information in the training class and application specific questions—if the score on the first examination is greater than or equal to a first predetermined passing score. Finally, the method includes the step 32 of internally qualifying the person in the field of study if the score on the second examination is greater than or equal to a second predetermined passing score.

### FIELD OF THE INVENTION

This invention relates to a method for training a person, and, in particular, to a method for training and internally qualifying the person in a particular field of study.

### BACKGROUND OF THE INVENTION

Companies and businesses have long used training classes to educate employees in particular fields of study. Generally, companies will send employees to training classes to teach them how to perform specific tasks related to their job. Companies may provide in-house training classes and may provide an examination to qualify people in a particular field of study. Internally qualifying a person corresponds to an entity (e.g., a company, a business, a non-profit organization, or an educational institution) that employs a person, to internally recognize that the person has at least a threshold level of knowledge in a particular field or area of study. The field of study may encompass the instructional information provided in one or more in-house training classes.

Conventional training methods, however, have several problems associated therewith. A first problem associated with conventional training methods is that a person often forgets a relatively large portion of the instructional information upon completion of the training class and/or the associated examination. The person may forget the instructional information because they do not apply the information to (i) solve a specific problem, or (ii) to complete a specific task. A second problem associated with conventional training methods is that conventional examinations generally do not have application specific questions that require the person to know how to apply the information to solve “real world” problems. A third problem associated with conventional training methods is that companies will often send groups of employees to the in-house training class without determining if some of the employees have the experience and knowledge to pass an associated examination without taking the training class. Accordingly, conventional training methods may not specifically target those employees who need the training resulting in increased training costs.

There is thus a need for a method of training and internally qualifying a person in a particular field of study that reduces or minimizes the above-identified problems.

### SUMMARY OF THE INVENTION

The present invention provides a method for training and internally qualifying a person in a particular field of study. In particular, the method may be utilized by companies, businesses, non-profit organizations, or educational institutions for training and internally qualifying people in particular fields of study.

The method in accordance with the present invention includes the step of determining if a person needs to take a training class prior to taking an internal qualification examination (i.e., a second examination) in the field of study. The method further includes the step of providing a training class related to the field of study. The training class may include computer-based instruction or classroom instruction. The method further includes the step of providing a first examination containing questions related to instructional information provided in the training class. The first examination may be a computer-based examination containing a set of multiple-choice questions. Upon completion of the first examination, a first score is determined. The method further includes the step of providing a project wherein the instructional information is utilized to complete a task in the project. The method further includes the step of providing the second examination containing questions related to the instructional information in the training class. The second examination may further include application specific questions related to information acquired by the person while completing tasks in the project. Upon completion of the second examination (i.e., internal qualification examination), a second score is determined. Finally, the method includes the step of internally qualifying the person in the field of study if the second score is greater than or equal to a second predetermined passing score on the second examination.

A method for training and internally qualifying a person in a particular field of study in accordance with the present invention represents a significant improvement over conventional training methods. A first advantage of the inventive method is that the person will most likely remember a greater portion of the instructional information, as compared to conventional training methods, since the person will utilize the information in completing two examinations (i.e., first and second examinations) and a project. A second advantage of the inventive method is that the second examination may include application specific questions that require the person to have a thorough understanding of how to apply the instructional information to solve “real world” problems. A third advantage of the inventive method is that the person may elect to forego the training class if the person has sufficient knowledge and experience in a particular field to pass the second examination. Accordingly, the inventive method provides training to only those individuals who need the training to become internally qualified in the field of study, resulting in lower training costs.

These and other features and advantages of this invention will become apparent to one skilled in the art from the following detailed description and the accompanying drawings illustrating features of this invention by way of example.

### BRIEF DESCRIPTION OF THE DRAWINGS

FIG. 1 is a flowchart illustrating a method for training and internally qualifying a person in a particular field of study in accordance with the present invention.

FIG. 2 is a block diagram of a system for providing computer-based instruction and examinations in accordance with the present invention.

### DETAILED DESCRIPTION OF THE PREFERRED EMBODIMENT

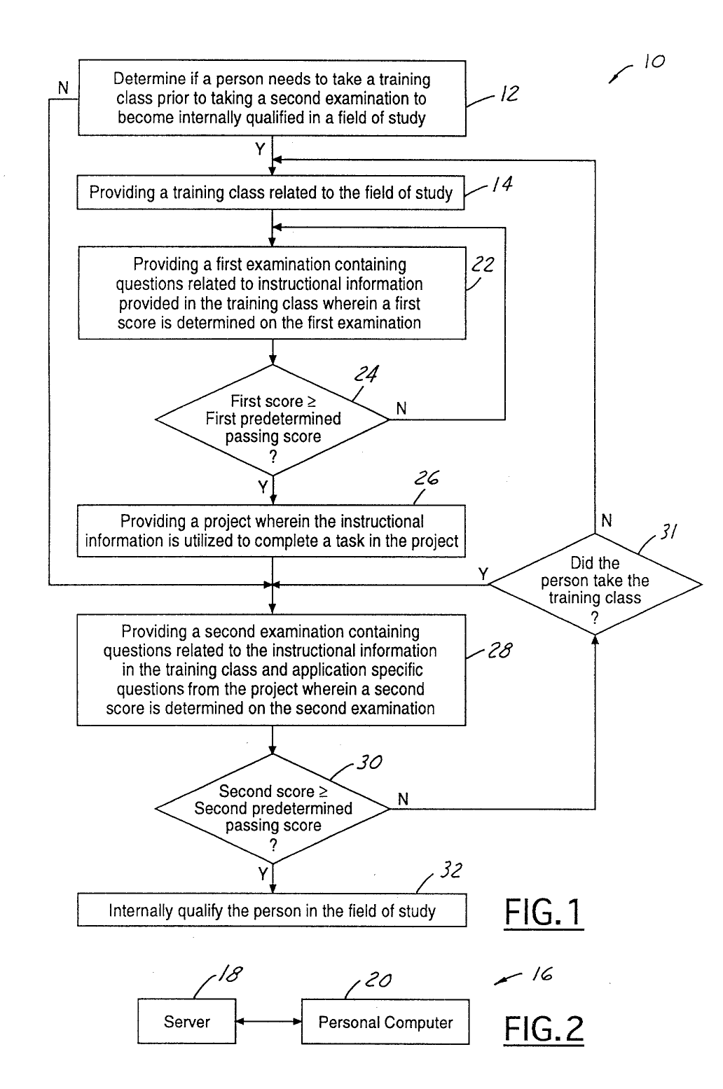

Referring now to the drawings wherein like reference numerals are used to identify identical components in the various views, FIG. 1 illustrates a method 10 for training and internally qualifying a person in accordance with the present invention. The method 10 may be utilized by entities such as companies, businesses, non-profit organizations, or educational institutions to train and internally qualify people in particular fields of study.

The method 10 in accordance with the present invention includes a step 12 that determines if a person needs to take a training class prior to taking a second examination (i.e., internal qualification examination) to become internally qualified in a field of study. The step 12 may include a substep of meeting with the person to determine if the person has sufficient experience and knowledge to pass the internal qualification examination. For example, in a company, a supervisor may meet with an employee and conduct an interview to determine the employee's knowledge and experience in a particular field of study. The supervisor may compare the employee's knowledge and experience with the knowledge required to pass the associated internal qualification examination—to determine if the employee needs to take the training class related thereto. If it is determined that the person needs to take the training class before taking the internal qualification examination, the method advances to a step 14. If it is determined that the person does not need to take the training class before taking the internal qualification examination, the method advances to a step 28.

The method 10 further includes the step 14 that provides a training class related to the field of study. The training class may include either computer-based instruction or classroom instruction. If the training class utilizes computer-based instruction, the step 14 may include a substep of scheduling a meeting with an instructor upon completion of the training class. The meeting with the instructor provides a means for the person to obtain answers to any questions that arose during the computer-based instruction.

Referring to FIG. 2, a system 16 is shown for providing the computer-based instruction. The system 16 includes a server 18 and a personal computer 20 that communicates with the server 18. The system 16 may utilize conventional instructional software stored in a nonvolatile memory of the server 18 and/or the computer 20 that displays selected instructional information on a computer monitor (not shown). The computer monitor is connected to the computer 20. The conventional instructional software may allow the person to selectively view the instructional information associated with a particular training class on the computer monitor. An advantage of the computer-based instruction is that the person can complete the training class at his or her own pace.

The classroom instruction associated with the step 14 may comprise a lecture format wherein an instructor presents the instructional information to the person. The classroom instruction may further include providing training class manuals containing the instructional information covered in the training class.

Referring to FIG. 1, the method 10 further includes a step 22 following the step 14 that provides a first examination containing questions related to instructional information provided in the training class. The first examination is provided to verify that the person has retained at least a threshold level of instructional information upon completion of the training class. The first examination may comprise (i) a set of multiple-choice questions, (ii) a set of essay questions, or (iii) a combination of multiple-choice questions and essay questions. Further, the first examination may comprise a computer-based examination or a written examination. Upon completion of the first examination a score is calculated based upon the number of correct answers.

Referring to FIG. 2, the step 22 may be implemented by using the system 16. The system 16 may display the first examination questions, accept answers input by the person, and calculate the score obtained on the first examination. In particular, the system 16 may utilize conventional examination software—stored in the nonvolatile memory of the server 18 and/or the computer 20—that selectively and sequentially displays multiple-choice questions on a computer monitor (not shown). Further, the person taking the first examination may input answers (e.g., answers A, B, C, or D) via a computer keyboard (not shown) connected to the computer 20. The answers may be stored in the nonvolatile memory. Upon completion of the first examination, the examination software may calculate the score obtained on the first examination and display the score on the computer monitor.

Referring to FIG. 1, the method 10 further includes a step 24 that determines whether the score on the first examination is greater than or equal to a first predetermined passing score. If the score on the first examination is greater than or equal to the first predetermined passing score—indicating the person passed the first examination—the method 10 advances to a step 26. If the score on the first examination is less than the first predetermined passing score—indicating the person failed the first examination—the method 10 returns to the step 22. Accordingly, the method 10 allows the person to iteratively take the first examination for a predetermined number of times until the person passes the first examination. However, if the person is unable to pass the first examination after the predetermined number of times, the person may meet with an instructor and/or a supervisor to determine whether additional training is required.

The method 10 further includes the step 26 that provides a project wherein the instructional information from the training class is utilized to complete a task in the project. The project may comprise a relatively small project. For example, if a person attended a training class covering quality control methodologies for manufacturing processes, a work-related project may comprise determining whether a manufacturing process is statistically stable. A task associated with the project may include calculating a standard deviation—using an equation provided in the training class—of certain measured values on a product produced by the manufacturing process. Alternately, the project may comprise a relatively large project utilizing a relatively large portion of the instructional information provided in the training class. Completing the project related to the instructional information in the training class allows the person to more thoroughly understand the information and to better retain the information. Upon completion of the step 26, the method 10 advances to the step 28.

The method 10 further includes the step 28 that provides a second examination to become internally qualified in a field of study. The second examination may contain questions related to the instructional information in the training class. Further, the second examination may include questions related to information acquired by the person while completing a task in the project and/or other application specific questions. The second examination may comprise (i) a set of multiple-choice questions, (ii) a set of essay questions, or (iii) a combination of multiple-choice questions and essay questions. Further, the second examination may comprise a computer-based examination or a written examination. Upon completion of the second examination, a score is calculated based upon the number of correct answers.

The step 28 may be implemented by using the system 16. The system 16 may display the second examination questions, accept answers input by the person, and calculate the score obtained on the second examination. As previously discussed, the system 16 may utilize conventional examination software—stored in the nonvolatile memory of the server 18 and/or the computer 20—that selectively and sequentially displays multiple-choice questions on a computer monitor (not shown). Further, the person taking the second examination may input answers (e.g., answers designated as A, B, C, or D) via a computer keyboard (not shown). Upon completion of the second examination, the examination software may calculate the score obtained on the second examination and display the score on the computer monitor. After completing the step 28, the method 10 advances to a step 30.

The method 10 further includes the step 30 that determines whether the score on the second examination is greater than or equal to a second predetermined passing score. If the score on the second examination is greater than or equal to the second predetermined passing score, the method 10 proceeds to a step 32. If the score on the second examination is less than the second predetermined passing score, the method 10 proceeds to a step 31.

The method 10 further includes the step 31 that determines if the person took the training class in the event the person failed the second examination. If the person took the training class—prior to taking the second examination—then the method 10 returns to the step 28 that provides the second examination again to the person. Further, the person preferably has to wait a predetermined time period between the step 31 and the step 28, which provides the person with additional time to study for the second examination. In the step 31, if the person did not take the training class—prior to taking the second examination—then the method 10 advances to the step 14 which provides the training class related to the field of study.

Finally, the method 10 includes the step 32 of internally qualifying the person in the field of study if the person passed the second examination. As previously discussed, internally qualifying the person corresponds to an entity that employs a person, to internally recognize that the person has at least a threshold level of knowledge in a particular field or area of study.

A method for training and internally qualifying a person in a particular field of study in accordance with the present invention represents a significant improvement over conventional methods. A first advantage of the inventive method is that the person will most likely remember a greater portion of the instructional information, as compared to conventional methods, since the person will utilize the information in completing two examinations (i.e., the first and second examinations) and a project. A second advantage of the inventive method is that the second examination may include application specific questions that require the person to have a thorough understanding of how to apply the instructional information to solve “real world” problems. A third advantage of the inventive method is that the person may elect to forego the training class if they have sufficient knowledge and experience to pass the second examination for internal qualification in the field of study, which reduces associated training costs.

While the invention has been particularly shown and described with reference to the preferred embodiment thereof, it is well understood by those skilled in the art that various changes and modifications can be made in the invention without departing from the spirit and scope of the invention.

We claim:

1. A method for training and internally qualifying a person in a particular field of study, comprising the steps of:
providing a training class related to said field of study wherein a type of instruction in said training class includes one of computer-based instruction and classroom instruction;
providing a first examination containing questions related to instructional information provided in said training class wherein a first score is determined on said first examination;
providing a project wherein said instructional information is utilized to complete a task in said project; and,
if said first score is greater than or equal to a first predetermined passing score on said first examination, then providing a second examination containing questions related to said instructional information in said training class wherein a second score is determined on said second examination.

2. The method of claim 1 wherein said step of providing said training class includes the following substep:
if said type of instruction is computer-based instruction, then scheduling a meeting with an instructor upon completion of said training class.

3. The method of claim 1 wherein said first examination is a computer-based examination comprising a set of multiple-choice questions.

4. The method of claim 1 wherein said second examination is a computer-based examination comprising a set of multiple-choice questions.

5. The method of claim 1 wherein said second examination further includes questions related to information acquired by said person while completing said task in said project.

6. The method of claim 1 further comprising the step of:
determining if said person needs to take said training class prior to taking said second examination to become internally qualified in said field of study.

7. The method of claim 1 further comprising the step of:
if said second score is greater than or equal to a second predetermined passing score on said second examination, then internally qualifying said person in said field of study.

8. A method for training and internally qualifying a person in a particular field of study, comprising the steps of:
providing a training class related to said field of study;
iteratively providing a first examination while a first score on said first examination is less than a first predetermined passing score and said first examination has not been provided greater than a predetermined number of times, said first examination containing questions related to instructional information provided in said training class;
providing a project wherein said instructional information is utilized to complete a task in said project;
if said first score is greater than or equal to a first predetermined passing score on said first examination, then providing a second examination containing questions related to said instructional information in said training class wherein a second score is determined on said second examination.

9. The method of claim 8 wherein said step of providing said training class includes the following substep:
if a type of instruction in said training class is computer-based instruction, then scheduling a meeting with an instructor upon completion of said training class.

10. The method of claim 8 wherein said first and second examinations are computer-based examinations comprising first and second sets of multiple-choice questions, respectively.

11. The method of claim 8 further comprising the step of:
if said second score is less than a second predetermined passing score on said second examination, then providing said second examination again after a predetermined time period has passed.

12. The method of claim 8 wherein said second examination further includes questions related to information acquired by said person while completing said task in said project.

13. The method of claim 8 further comprising the step of:
determining if said person needs to take said training class prior to taking said second examination to become internally qualified in said field of study.

14. The method of claim 8 further comprising the step of:
if said second score is greater than or equal to a second predetermined passing score on said second examination, then internally qualifying said person in said field of study.

15. A method for training and internally qualifying a person in a particular field of study, comprising the steps of:
determining if said person needs to take a training class prior to taking a second examination to become internally qualified in said field of study;
if said person needs to take said training class, then performing the following steps a-c;
a. providing said training class related to said field of study;
b. providing a first examination containing questions related to instructional information provided in said training class wherein a first score is determined on said first examination;
c. providing a project wherein said instructional information is utilized to complete a task in said project;
if said first score is greater than or equal to a first predetermined passing score on said first examination or said person does not need to take said training class, then providing said second examination containing questions related to said instructional information in said training class wherein a second score is determined on said second examination.

16. The method of claim 15 wherein said step of determining if said person needs to take a training class includes the substep of:
meeting with said person to determine if said person has sufficient experience and knowledge to pass said second examination.

17. The method of claim 15 wherein said first examination is a computer-based examination comprising a set of multiple-choice questions.

18. The method of claim 15 wherein said second examination is a computer-based examination comprising a set of multiple-choice questions.

19. The method of claim 15 further comprising the step of:
if said second score is greater than or equal to a second predetermined passing score on said second examination, then internally qualifying said person in said field of study.

20. The method of claim 15 further comprising the step of:
if said second score is less than said second predetermined passing score on said second examination, then providing said second examination again after a predetermined time period has passed.
